(19) United States
(12) Patent Application Publication
(10) Pub. No.: US 2026/0244082 A1
(43) Pub. Date: Aug. 20, 2026

(54) REFLECTION COMPONENT AND CAMERA MODULE

(71) Applicant: NINGBO SUNNY OPOTECH CO., LTD., Zhejiang (CN)

(72) Inventors: Yuxiang WANG, Zhejiang (CN); Guoquan Hu, Zhejiang (CN); Qianjin CAO, Zhejiang (CN); Xiuxiu ZHOU, Zhejiang (CN); Shi XIONG, Zhejiang (CN); Peng LU, Zhejiang (CN); Shiqin YAO, Zhejiang (CN)

(73) Assignee: NINGBO SUNNY OPOTECH CO., LTD., Zhejiang (CN)

(21) Appl. No.: 19/345,610

(22) Filed: Sep. 30, 2025

(30) Foreign Application Priority Data
Feb. 17, 2025 (CN) 2025101696672

(51) Int. Cl. G03B 17/17

(52) U.S. Cl. CPC G03B 17/17

(57) ABSTRACT

The application discloses a reflection component and a camera module, wherein the reflection component comprises: a reflection element comprising a reflecting surface and a matching surface, and the reflecting surface is used for reflecting light propagating along a first optical axis to propagating along a second optical axis; a movable carrier used for carrying the reflection element; a reinforcing member arranged between the reflection element and the movable carrier so that the reflection element can be fixed to the movable carrier, wherein the reinforcing member comprises a first fixing portion, a second fixing portion and a partition gap which are integrally formed, the first fixing portion is used for being fixedly connected with the movable carrier, and the second fixing portion is used for being fixedly connected with the matching surface of the reflection element, and the first fixing portion is located at the peripheral side of the second fixing portion, and in the thickness direction of the reflection element, the projection of the fixed connection area between the first fixing portion and the movable carrier is offset from the projection of the fixed connection area between the second fixing portion and the matching surface, and the partition gap is located at the inner side of the first fixing portion so as to isolate the first fixing portion from the reflection element.

### RELATED APPLICATIONS

The present application claims priority to Chinese Application No. 2025101696672 (filed February 17, 2025), the contents of which are incorporated herein in their entirety.

### TECHNICAL FIELD

The present application relates to the technical field of camera modules, in particular to a reflection component and a camera module thereof.

### BACKGROUND ART

A camera module is an indispensable part of a mobile electronic device. With the further development of camera module technology, users' demands for camera modules are becoming more and more sophisticated. A periscope camera module usually needs to implement complex light reflection and turning in a limited space to achieve high-magnification zoom functions. Therefore, the stability and reliability of the reflection component are crucial to the performance of the entire periscope camera module. If the reflection element of the reflection component is deformed when subjected to external force, it will make it difficult for the light to propagate along the expected path, resulting in increased aberration; uneven deformation will also cause light at different positions to deviate to varying degrees, thereby causing the image field to bend.

In the related art, the reflection component of a periscope camera module is usually fixed to the movable carrier by bonding. However, during the thermal curing process of an adhesive member, the thermal deformation of a movable carrier will affect the reflection component, causing the reflecting surface of the reflection component to deform, resulting in a large deviation between the propagation path of the light and the expected path, thereby reducing the imaging quality of the camera module.

### SUMMARY

An object of the present application is to provide a reflection component, which is helpful to avoid deformation of the reflection element when it is fixed to a movable carrier, so as to improve the stability and reliability of the reflection component.

Another object of the present application is to provide a camera module having the above reflection component.

To achieve at least one of the above objects, the technical solution adopted by the present application is as follows: a reflection component including a reflection element, which comprises a reflecting surface and a matching surface, wherein the reflecting surface is used for reflecting light propagating along the first optical axis to propagating along the second optical axis; a movable carrier, which is used for carrying the reflection element; a reinforcing member, which is arranged between the reflection element and the movable carrier so that the reflection element can be fixed to the movable carrier, wherein the reinforcing member comprises a first fixing portion, a second fixing portion and a partition gap which are integrally formed, and the first fixing portion is used for being fixedly connected with the movable carrier, and the second fixing portion is used for fixedly connected with the matching surface of the reflection element, and the first fixing portion is located at the peripheral side of the second fixing portion, and the projection of the fixed connection area between the first fixing portion and the movable carrier is offset from the projection of the fixed connection area between the second fixing portion and the matching surface in the thickness direction of the reflection element; wherein the partition gap is located at the inner side of the first fixing portion, so that the partition gap is arranged between the first fixing portion and the second fixing portion, or is arranged on the second fixing portion so as to isolate the first fixing portion from the reflection element.

Preferably, in the thickness direction of the reflection element, a first gap is provided between the reinforcing member and the movable carrier, and a second gap is provided between the reinforcing member and the matching surface, and the projection of the first gap is offset from the projection of the second gap in the thickness direction of the reflection element.

Preferably, the first fixing portion and the second fixing portion extend in a same plane, and the first fixing portion is bonded to the movable carrier via a first adhesive member, and the first gap is located in the middle of the first adhesive member, and the second fixing portion is bonded to the matching surface via a second adhesive member, to define the second gap between the reinforcing member and the matching surface, and the second gap is located at the periphery of the second adhesive member, so that the projection of the first gap is offset from the projection of the second gap.

Preferably, the partition gap penetrates the reinforcing member in the thickness direction of the reinforcing member, and the partition gap is arranged around the second fixing portion, and is located between the first fixing portion and the second fixing portion, and the first fixing portion is suitable for being fixedly connected with the movable carrier, and the second fixing portion is suitable for being fixedly connected with the matching surface.

Preferably, the partition gap comprises a plurality of partition areas arranged at intervals, and the partition areas are distributed at intervals on the periphery of the second fixing portion to separate the first fixing portion from the second fixing portion.

Preferably, the partition gap comprises a plurality of partition areas arranged at intervals, and at least some of the partition areas are distributed at intervals on the second fixing portion, and in the thickness direction of the reflection element, the center of the projection area of the matching surface on the reinforcing member is defined as a central area, and the area of the central area is 20-30% of the total area of the projection area, and the central area overlaps at least partially with the partition areas.

Preferably, each of the partition areas extends in the second direction, and the partition areas are arranged at intervals in the first direction, the size of the partition area in the first direction is X₁, the distance between two adjacent partition areas is X₂, the distance from the partition area closest to the short side of the reinforcing member to the short side of the reinforcing member is X₃, and X₂ satisfies: 3X₁≤X₂≤6X₁, or 0.5 mm≤X₂≤2 mm, or 0.05X≤X₂≤0.2X; and X₃ satisfies: X₃≥X₂; or, each of the partition areas extends in the first direction, and the partition areas are arranged at intervals in the second direction, the size of the partition area in the second direction is Y₁, the distance between two adjacent partition areas is Y₂, the distance from the partition area closest to the long side of the reinforcing member to the long side of the reinforcing member is Y₃, and Y₂ satisfies: 3Y₁≤Y₂≤6Y₁, or 0.5 mm≤Y₂≤2 mm, or 0.06Y≤Y₂≤0.25Y; and Y₃ satisfies: Y₃≥Y₂; wherein X is the size of the matching surface of the reflection element in the first direction, and Y is the size of the matching surface in the second direction; the first direction is parallel to the long side of the reinforcing member, and the second direction is parallel to the short side of the reinforcing member.

Preferably, each of the partition areas is circular, and at least part of the partition areas are distributed in an array on the second fixing portion.

Preferably, the reinforcing member further comprises a supporting portion, and the supporting portion is capable of connecting the first fixing portion and the second fixing portion so that the plane where the first fixing portion is located and the plane where the second fixing portion is located are different planes and parallel to each other, and in the thickness direction of the reinforcing member, the projection of the first fixing portion and the projection of the second fixing portion do not overlap, and the partition gap is arranged around the edge of the second fixing portion, and the first fixing portion is bonded to the movable carrier via a first adhesive member, and the second fixing portion is bonded to the matching surface via a second adhesive member.

Preferably, the movable carrier comprises a carrier mounting wall, a first carrier side wall and a second carrier side wall, the carrier mounting wall is obliquely arranged to define a mounting surface on the surface of the carrier mounting wall facing the reflection element, and the mounting surface is suitable for being bonded and fixed to the first fixing portion, and the first carrier side wall and the second carrier side wall are located at opposite sides of the carrier mounting wall at intervals in a direction of a third axis, and an accommodating cavity is formed between the first carrier side wall, the second carrier side wall and the mounting surface, and the accommodating cavity is used for accommodating the reflection element.

Preferably, the thickness of the reinforcing member is H, the thickness of the carrier mounting wall is L, and the thickness of the reflection element is T, and L≤H≤T.

Preferably, the reinforcing member further comprises an embedding portion, which is bent and extended from the first fixing portion toward the movable carrier and embedded in the movable carrier, and at least part of the first fixing portion is embedded in the movable carrier so that the first fixing portion is connected with the movable carrier by embedding, and the second fixing portion is bonded to the matching surface via a second adhesive member.

Preferably, the movable carrier comprises a carrier bottom wall, a first carrier side wall, a second carrier side wall and a carrier back wall, and the carrier bottom wall is arranged perpendicular to the first optical axis, and the first carrier side wall and the second carrier side wall are located at opposite sides of the carrier bottom wall in the direction of a third axis, and the carrier back wall connects the first carrier side wall and the second carrier side wall, and the reinforcing member is obliquely arranged between the first carrier side wall and the second carrier side wall, and the second fixing portion of the reinforcing member is spaced apart from the carrier bottom wall in the direction of the first optical axis, and the second fixing portion of the reinforcing member is spaced apart from the carrier back wall in the direction of the second optical axis, and the embedding portion of the reinforcing member is embedded in at least one of the carrier bottom wall, the first carrier side wall, the second carrier side wall and the carrier back wall, and the third axis is perpendicular to the first optical axis and the second optical axis.

Preferably, at least one of the following conditions is satisfied: the area of the first fixing portion is N₁, and the area of the second fixing portion is N₂, and N₁≥0.5N₂; the area of the matching surface of the reflection element is M, and the area of the matching surface bonded to the second fixing portion is M₁, and 0.3M≤M₁≤0.7M; and the thermal expansion coefficient of the reflection element is C₁, the thermal expansion coefficient of the reinforcing member is C₂, and 0.25C₂≤C₁≤0.75C₂.

Preferably, the reflection component further comprises a bracket, a first lens and a second lens, and the bracket is fixed to the movable carrier so as to be suitable for moving synchronously with the movable carrier, and the first lens is carried by the bracket to be arranged opposite to the reflection element along the first optical axis, and the second lens is carried by the bracket to be arranged opposite to the reflection element along the second optical axis.

In order to achieve at least one of the above objects, the technical solution adopted by the present application is as follows: a camera module, which comprises: the reflection component as described above; a lens component, which is held on a light reflection path of the reflection component; an imaging component, which receives the light emitted by the lens component to perform imaging; a base, which has a receiving cavity, wherein the reflection component and the lens component are arranged in the receiving cavity; and a shell covering the base.

Compared with the prior art, the present application has the following beneficial effects:
(1) The first fixing portion of the reinforcing member is fixedly connected with the movable carrier, and the second fixing portion is fixedly connected with the matching surface of the reflection element, and the partition gap is located at the inner side of the first fixing portion, that is, the partition gap is arranged between the first fixing portion and the second fixing portion, or is arranged on the second fixing portion, so as to isolate the first fixing portion from the reflection element, accordingly, when the movable carrier is heated, the force generated by the deformation of the movable carrier will be applied to the first fixing portion, furthermore, the stress can be absorbed by the first fixing portion and the second fixing portion, and the partition gap is helpful to further avoid the stress from being transmitted to the reflection element, thereby reducing the influence of the force generated by the deformation of the movable carrier on the reflection element, which is helpful to improve the reliability and stability of the reflection component.
(2) In particular, when the first fixing portion is fixedly connected with the movable carrier by an adhesive, and the second fixing portion is fixedly connected with the matching surface of the reflection element by an adhesive, the projection of the fixed connection area between the first fixing portion and the movable carrier and the projection of the fixed connection area between the second fixing portion and the matching surface are configured alternatively, that is, the projection of the fixed connection area between the first fixing portion and the movable carrier and the projection of the fixed connection area between the second fixing portion and the matching surface do not overlap, which helps to avoid the accumulation of curing stress of the adhesive in the thickness direction of the reflection element, and furthermore, in the direction parallel to the matching surface, the curing stress of the adhesive can be dispersed by the partition gap, which is also beneficial to avoid the accumulation of curing stress, so as to further improve the reliability and stability of the reflection component.

### BRIEF DESCRIPTION OF THE DRAWINGS

FIG. 1 is an exploded view of a reflection component according to some examples of the present application.

FIG. 2 is a schematic diagram of bonding of a reflection element, a reinforcing member, and a movable carrier according to some examples of the present application.

FIG. 3 is a sectional view of a reflection component according to some examples of the present application.

FIG. 4 is a schematic diagram of a three-dimensional structure of a reinforcing member according to some examples of the present application.

FIG. 5 is a schematic diagram of a three-dimensional structure of a reinforcing member according to other examples of the present application.

FIG. 6 is a schematic diagram of a three-dimensional structure of a reinforcing member according to other examples of the present application.

FIG. 7 is a schematic diagram of the arrangement of the partition areas of the reinforcing member according to Example 1 of the present application.

FIG. 8 is a schematic diagram of the arrangement of the partition areas of the reinforcing member according to Example 2 of the present application.

FIG. 9 is a schematic diagram of the arrangement of the partition areas of the reinforcing member according to Example 3 of the present application.

FIG. 10 is a schematic diagram of the arrangement of the partition areas of the reinforcing member according to Example 4 of the present application.

FIG. 11 is a schematic diagram of the arrangement of the partition areas of the reinforcing member according to Example 5 of the present application.

FIG. 12 is a schematic diagram of another arrangement of partition areas of the reinforcing member according to Example 5 of the present application.

FIG. 13 is a schematic diagram of the arrangement of the partition areas of the reinforcing member according to Example 6 of the present application.

FIG. 14 is a schematic diagram of the arrangement of the partition areas of the reinforcing member according to Example 7 of the present application.

FIG. 15 is a schematic diagram of another arrangement of partition areas of the reinforcing member according to Example 7 of the present application.

FIG. 16 is a schematic diagram of the arrangement of the partition areas of the reinforcing member according to Example 8 of the present application.

FIG. 17 is a schematic diagram of the arrangement of the partition areas of the reinforcing member according to Example 9 of the present application.

FIG. 18 is a schematic diagram of another arrangement of partition areas of the reinforcing member according to Example 9 of the present application.

FIG. 19 is a schematic diagram of the arrangement of the partition areas of the reinforcing member according to Example 10 of the present application.

FIG. 20 is a schematic diagram of the arrangement of the partition areas of the reinforcing member according to Example 11 of the present application.

FIG. 21 is a schematic diagram of the arrangement of the partition areas of the reinforcing member according to Example 12 of the present application.

FIG. 22 is a schematic diagram of the three-dimensional structure of the reinforcing member according to Example 13 of the present application.

FIG. 23 is a schematic diagram of the three-dimensional structure of the reinforcing member according to Example 14 of the present application.

FIG. 24 is a schematic diagram of the three-dimensional structure of the reinforcing member according to Example 15 of the present application.

FIG. 25 is a schematic diagram of the three-dimensional structure of another reinforcing member according to Example 15 of the present application.

FIG. 26 is a sectional view of a camera module according to some examples of the present application.

In the above figures: 1. Reflection component; 10. Reflection element; 11. Reflecting surface; 12. Matching surface; 20. Movable carrier; 21. Carrier mounting wall; 211. Mounting surface; 22. First carrier side wall; 23. Second carrier side wall; 24. Carrier bottom wall; 25. Carrier back wall; 26. Accommodating cavity; 30. Reinforcing member; 31. First fixing portion; 32. Second fixing portion; 33. Partition Gap; 331. Partition area; 34. Supporting portion; 35. Embedding portion; 351. First embedding portion; 352. Second embedding portion; 353. Third embedding portion; 41. First gap; 42. Second gap; 51. First adhesive member; 52. Second adhesive member; 60. Bracket; 71. First lens; 72. Second lens; 2. Camera module; 81. Lenses module; 811. First lens group; 812. Second lens group; 82. Imaging module; 91. Base; 911. Receiving cavity; 92. Shell.

### DETAILED DESCRIPTION

The present application is further described below in conjunction with particular examples. It should be noted that, under the premise of no conflict, the various examples or technical features described below can be arbitrarily combined to form a new example.

In the description of the present application, it should be noted that directional words, such as the terms “center”, “lateral”, “longitudinal”, “length”, “width”, “thickness”, “up”, “down”, “front”, “back”, “left”, “right”, “vertical”, “horizontal”, “top”, “bottom”, “inside”, “outside”, “clockwise”, “counterclockwise”, etc., indicating directions and positional relationships are based on the directions or positional relationships shown in the accompanying drawings, which are only for the convenience of narrating the present application and simplifying the description, and do not indicate or imply that the device or element referred to must have a specific orientation, be constructed and operated in a specific orientation, and cannot be understood as limiting the specific protection scope of the present application.

It should be noted that, the terms “first”, “second”, etc. in the description and claims of the present application are used to distinguish similar objects, and are not necessarily used to describe a specific order or sequence.

The terms “comprise/comprising”, “include/including” and “have/has/having” and any variations thereof in the specification and claims of this application are intended to cover non-exclusive inclusions. For example, a process, method, system, product or device comprising a series of steps or units is not necessarily limited to those steps or units explicitly listed, but may comprise other steps or units not explicitly listed or inherent to these processes, methods, products or devices.

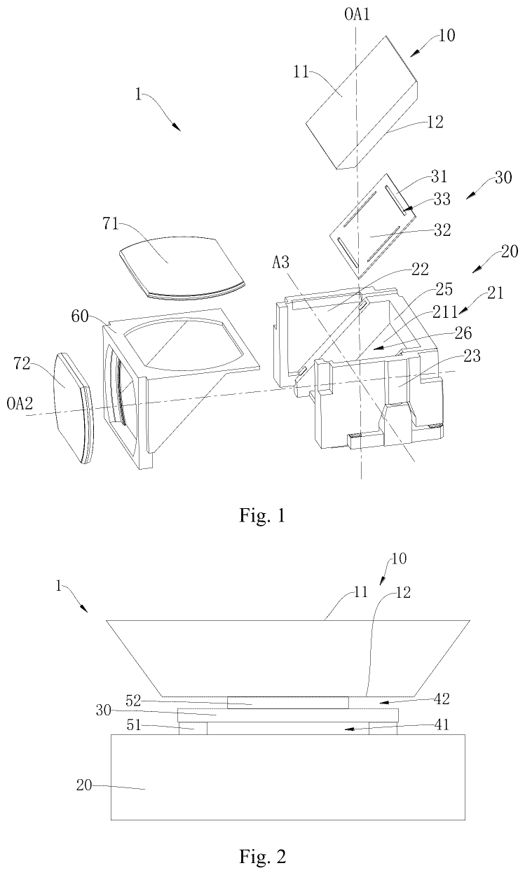

A reflection component 1 as shown in FIGS. 1-25 comprises: a reflection element 10, a movable carrier 20 and a reinforcing member 30. The reflection element 10 comprises a reflecting surface 11 and a matching surface 12. The reflecting surface 11 is used for reflecting the light propagating along the first optical axis OA1 to propagating along the second optical axis OA2. The movable carrier 20 is used for carrying the reflection element 10 so as to drive the reflection element 10 to rotate around an axis parallel to the first optical axis OA1, or to rotate around an axis parallel to the second optical axis OA2, or to rotate around a third axis A3, wherein the third axis A3 is perpendicular to the first optical axis OA1 and the second optical axis OA2. The reinforcing member 30 is arranged between the reflection element 10 and the movable carrier 20, so that the reflection element 10 is fixed to the movable carrier 20. The reinforcing member 30 comprises an integrally formed first fixing portion 31, a second fixing portion 32 and a partition gap 33. The first fixing portion 31 is used to be fixedly connected with the movable carrier 20, and the second fixing portion 32 is used to be fixedly connected with the matching surface 12 of the reflection element 10. The first fixing portion 31 is located at the peripheral side of the second fixing portion 32, and in the thickness direction of the reflection element 10, the projection of the fixed connection area between the first fixing portion 31 and the movable carrier 20 is offset from the projection of the fixed connection area between the second fixing portion 32 and the matching surface 12; the partition gap 33 is located at the inner side of the first fixing portion 31, so that the partition gap 33 is arranged between the first fixing portion 31 and the second fixing portion 32, or is arranged on the second fixing portion 32, so as to isolate the first fixing portion 31 from the reflection element 10.

Particularly, during the manufacturing and usage of the reflection component 1, the reflection element 10 and the movable carrier 20 may be subjected to heating and undergo thermal expansion and contraction. For example, when the reflection element 10 is fixed to the movable carrier 20 with an adhesive, if UV light curing glue is used, the reflecting surface 11 of the reflection element 10 will reflect the ultraviolet light, making it difficult for the ultraviolet light to irradiate between the reflection element 10 and the movable carrier 20, and the bonding strength of the UV light curing glue is low. Therefore, heat-curing glue is usually used to bond the reflection element 10 to the movable carrier 20. It should be understood that, the movable carrier 20 needs to be heated during the heat-curing process, so that the movable carrier 20 and the reflection element 10 may undergo thermal expansion and contraction. For another example, a driving coil in a driving assembly for driving the movable carrier 20 to move will generate heat when powered on, and the heat will also be transferred to the movable carrier 20, thereby causing the movable carrier 20 and the reflection element 10 to undergo thermal expansion and contraction.

Furthermore, because the coefficient of thermal expansion (CTE) of the reflection element 10 differs from that of the movable carrier 20, the two components undergo different amounts of deformation during the heating and cooling process, i.e., when the temperature changes. If the reflection element 10 is directly bonded to the movable carrier 20, stress may be generated between the reflection element 10 and the movable carrier 20, thereby causing the reflecting surface 11 of the reflection element 10 to deform, e.g., the reflecting surface 11 being convex, concave, or unevenly deformed, making it difficult for the light reflected by the reflecting surface 11 to propagate along the expected path, resulting in a reduction in the imaging quality of the camera module 2.

In the present example, the first fixing portion 31 of the reinforcing member 30 is fixedly connected with the movable carrier 20, the second fixing portion 32 is fixedly connected with the matching surface 12 of the reflection element 10, and the partition gap 33 is located at the inner side of the first fixing portion 31. That is, the partition gap 33 is arranged between the first fixing portion 31 and the second fixing portion 32, or is arranged on the second fixing portion 32, so as to isolate the first fixing portion 31 from the reflection element 10. Accordingly, when the movable carrier 20 is heated, the force generated by the deformation of the movable carrier 20 will be applied to the first fixing portion 31. Furthermore, stress can be absorbed by the first fixing portion 31 and the second fixing portion 32, and the partition gap 33 can further prevent stress from being transferred to the reflection element 10, thereby reducing the effect of the force generated by the deformation of the movable carrier 20 on the reflection element 10, reducing the deformation of the reflecting surface 11, and helping to keep the reflecting surface 11 in the expected surface shape, and thereby improving the reliability and stability of the reflection component 1.

Especially when the first fixing portion 31 is fixedly connected with the movable carrier 20 by an adhesive, and the second fixing portion 32 is fixedly connected with the matching surface 12 of the reflection element 10 by an adhesive, the projection of the fixed connection area between the first fixing portion 31 and the movable carrier 20 is offset from the projection of the fixed connection area between the second fixing portion 32 and the matching surface 12. That is, the projection of the fixed connection area between the first fixing portion 31 and the movable carrier 20 and the projection of the fixed connection area between the second fixing portion 32 and the matching surface 12 do not overlap, thereby helping to prevent the accumulation of curing stress of the adhesive in the thickness direction of the reinforcing member 30. Furthermore, in the direction parallel to the matching surface 12, the curing stress of the adhesive can be dispersed by the partition gap 33, which is also beneficial to avoid the accumulation of curing stress, so as to further improve the reliability and stability of the reflection component 1.

It should be understood that, the first fixing portion 31 is located at the peripheral side of the second fixing portion 32, which is beneficial to increasing the area of the first fixing portion 31, that is, it is beneficial to increase the area on the first fixing portion 31 used for fixing to the movable carrier 20, thereby improving the connection strength and connection reliability between the reinforcing member 30 and the movable carrier 20.

It is worth mentioning that, as shown in FIG. 2, the area of the matching surface 12 of the reflection element 10 can be larger than the area of the second fixing portion 32. That is, in the height direction of the reflection element 10, the projection of the matching surface 12 can extend to the first fixing portion 31 of the reinforcing member 30, so as to make full use of the space inside the reflection component 1, resulting in a more compact structure among the reflection element 10, the reinforcing member 30 and the movable carrier 20, and the volume of the reflection element 10 is increased while ensuring that the overall size of the reflection component 1 is small, which is beneficial to increase the area of the reflecting surface 11, increase the amount of light entering the camera module 2, and reduce light loss.

In some examples, as shown in FIG. 2, in the thickness direction of the reflection element 10, a first gap 41 is provided between the reinforcing member 30 and the movable carrier 20, and a second gap 42 is provided between the reinforcing member 30 and the matching surface 12, and the projection of the first gap 41 is offset from the projection of the second gap 42 in the thickness direction of the reflection element 10.

It should be understood that, the first gap 41 provides deformation space for the reinforcing member 30 and the movable carrier 20. Particularly, on the reinforcing member 30, except for the portion of the first fixing portion 31 that is fixedly connected with the movable carrier 20, the first gap 41 is provided between the other portions of the reinforcing member 30 and the movable carrier 20, thereby helping to avoid the transfer of stress caused by contact between the reinforcing member 30 and the movable carrier 20 when the reinforcing member 30 and the movable carrier 20 are deformed due to temperature changes.

Similarly, the second gap 42 provides a deformation space for the reinforcing member 30 and the reflection element 10. Particularly, on the reinforcing member 30, except for the portion of the second fixing portion 32 that is fixedly connected with the matching surface 12, the second gap 42 is provided between the other portions of the reinforcing member 30 and the reflection element 10, thereby helping to avoid the transfer of stress caused by contact between the reinforcing member 30 and the reflection element 10 when the reinforcing member 30 and the reflection element 10 are deformed due to temperature changes.

Furthermore, in the thickness direction of the reflection element 10, the projection of the fixed connection area between the first fixing portion 31 and the movable carrier 20 and the projection of the fixed connection area between the second fixing portion 32 and the matching surface 12 do not overlap, thereby the projection of the first gap 41 is offset from the projection of the second gap 42. That is, the projection positions of the first gap 41 and the second gap 42 do not completely overlap, which helps to disperse the stress on the reinforcing member 30, reduce stress concentration, and avoid fatigue damage to the reinforcing member 30, thereby extending the service life of the reinforcing member 30.

In some examples, as shown in FIGS. 1-2, the first fixing portion 31 and the second fixing portion 32 extend in the same plane, the first fixing portion 31 is bonded to the movable carrier 20 via the first adhesive member 51, and the first gap 41 is located in the middle of the first adhesive member 51; the second fixing portion 32 is bonded to the matching surface 12 via the second adhesive member 52, to define the second gap 42 between the reinforcing member 30 and the matching surface 12; and the second gap 42 is located at the periphery of the second adhesive member 52, so that the projection of the first gap 41 is offset from the projection of the second gap 42.

Particularly, the first fixing portion 31 is bonded to the movable carrier 20 by adhesive, thereby forming the first adhesive member 51 between the first fixing portion 31 and the movable carrier 20; the second fixing portion 32 is bonded to the matching surface 12 by adhesive, thereby forming the second adhesive member 52 between the second fixing portion 32 and the matching surface 12.

It should be understood that, the first adhesive member 51 has a certain height, so as to form a first gap 41 between the reinforcing member 30 and the movable carrier 20. In combination with the above description, the first fixing portion 31 is located at the peripheral side of the second fixing portion 32, and thus the second gap 42 is located in the middle of the first adhesive member 51. That is, in the thickness direction of the reflection element 10, the projection of the second fixing portion 32 falls within the area enclosed by the projection of the first adhesive member 51, and the projection of the second fixing portion 32 does not overlap with the projection of the first adhesive member 51, to define the first gap 41 between the second fixing portion 32 and the movable carrier 20. It is worth mentioning that, the first gap 41 is also formed between a part of the first fixing portion 31 where the first adhesive member 51 is not provided and the movable carrier 20.

Furthermore, in combination with the foregoing, the second fixing portion 32 is used for bonding with the matching surface 12 of the reflection element 10. When the reinforcing member 30 and the movable carrier 20 are deformed due to temperature changes, the first gap 41 is conducive to avoiding contact between the reinforcing member 30 and the movable carrier 20. That is, the deformation of the movable carrier 20 is therefore prevented from transmitting to the reflection element 10 via the second fixing portion 32 and the second adhesive member 52 that contact the movable carrier 20, thereby reducing the deformation of the reflecting surface 11 of the reflection element 10 and enhancing the stability and reliability of the reflection component 1.

It should be understood that, the second adhesive member 52 has a certain height, so as to form the second gap 42 between the reinforcing member 30 and the reflection element 10. In combination with the foregoing, the area of the matching surface 12 of the reflection element 10 is larger than the area of the second fixing portion 32. That is, at least a part of the reflection element 10 is disposed opposite to the first fixing portion 31, to define the second gap 42 between the first fixing portion 31 and the reflection element 10. It is worth mentioning that, the second gap 42 is formed between a part of the second fixing portion 32 where the second adhesive member 52 is not disposed and the reflection element 10.

Furthermore, in combination with the foregoing, the first fixing portion 31 is used for bonding with the movable carrier 20. When the reinforcing member 30 and the reflection element 10 are deformed due to temperature changes, the second gap 42 is conducive to avoiding contact between the reinforcing member 30 and the reflection element 10. In other words, stress generated by the deformation of the reinforcing member 30 is thereby prevented from being transmitted to the reflection element 10 via any portion other than the second adhesive member 52, reducing the deformation of the reflecting surface 11 of the reflection element 10 and enhancing the stability and reliability of the reflection component 1.

In some examples, as shown in FIGS. 4-23, the partition gap 33 penetrates the reinforcing member 30 in the thickness direction of the reinforcing member 30, the partition gap 33 is arranged around the second fixing portion 32, and is located between the first fixing portion 31 and the second fixing portion 32; the first fixing portion 31 is suitable for being fixedly connected with the movable carrier 20, and the second fixing portion 32 is suitable for being fixedly connected with the matching surface 12. That is, an adhesive is provided between the matching surface 12 and the second fixing portion 32, thereby connecting the reflection element 10 to the reinforcing member 30, while no adhesive is provided between the matching surface 12 and the first fixing portion 31, thus, the reflection element 10 and the first fixing portion 31 are not directly connected, preventing deformation and stress of the first fixing portion 31 from being transmitted to the reflection component 1.

It should be understood that the partition gap 33 is arranged around the second fixing portion 32, thereby isolating the second fixing portion 32 from the first fixing portion 31 in multiple directions and preventing stress of the first fixing portion 31 from being transmitted to the second fixing portion 32 from multiple directions. This reduces the influence of the stress from the movable carrier 20 and the first fixing portion 31 on the second fixing portion 32 and the reflection element 10, thereby reducing or even eliminating deformation of the reflecting surface 11 of the reflection element 10 and improving the reliability and stability of the reflection component 1.

In some examples, as shown in FIGS. 7-21, the partition gap 33 comprises a plurality of partition areas 331 arranged at intervals. The partition areas 331 are spaced apart from each other on the periphery of the second fixing portion 32, so as to separate the first fixing portion 31 from the second fixing portion 32. Particularly, each partition area 331 is arranged rotationally symmetrical relative to the geometric center of the reinforcing member 30, or each partition area 331 is arranged symmetrical relative to the midline of the reinforcing member 30 parallel to a long side direction, or each partition area 331 is arranged symmetrical relative to the midline of the reinforcing member 30 parallel to a short side direction, thereby making the force on the reinforcing member 30 more balanced, and helping to avoid stress concentration.

Several non-limiting embodiments are provided below to further illustrate the technology of the present application. In the following embodiments, the reinforcing member 30 has two long sides arranged opposite to each other, which are denoted as the first side edge and the second side edge for the convenience of description; and the reinforcing member 30 has two short sides arranged opposite to each other, which are denoted as the third side edge and the fourth side edge for the convenience of description.

### EXAMPLE 1

As shown in FIG. 7, the reinforcing member 30 has four “I” shaped partition areas 331, each of which is arranged parallel to one of the first to fourth side edges, a first fixing portion 31 is defined between the partition area 331 and the corresponding side edge, and a second fixing portion 32 is defined in the middle area among the four partition areas 331. It should be understood that, the four partition areas 331 are used to isolate the first fixing portion 31 from the second fixing portion 32, which is beneficial to reduce the influence of the stress from the first fixing portion 31 located at the four sides on the second fixing portion 32 located in the middle area, and reduce the influence on the reflecting surface 11 of the reflection element 10.

### EXAMPLE 2

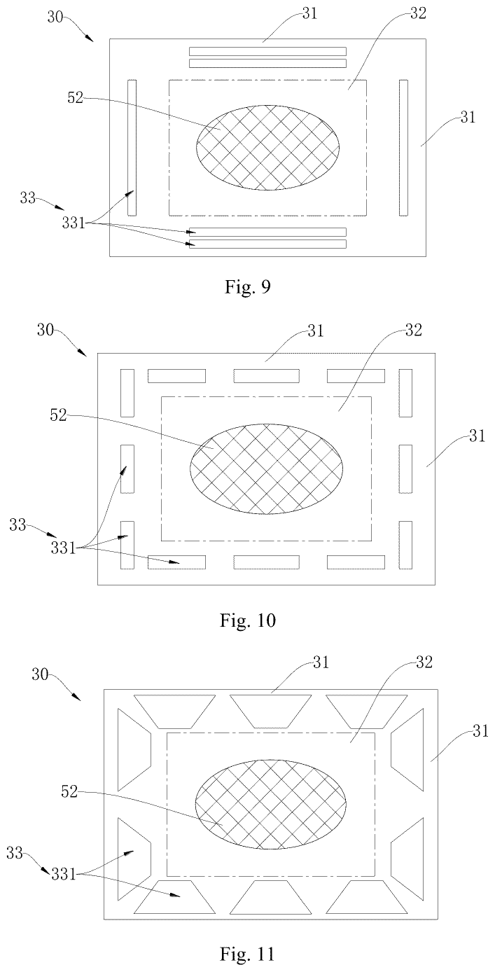

As shown in FIG. 8, the differences of Example 2 relative to Example 1 lie in that: from the first side edge to the fourth side edge, each corresponds to two partition areas 331 with equal length and being spaced apart along a direction perpendicular to the side edge extension direction. On the basis of ensuring the structural strength of the reinforcing member 30, the isolation distance between the first fixing portion 31 and the second fixing portion 32 is increased, which is beneficial to further reduce the influence of the stress from the first fixing portion 31 on the second fixing portion 32, and reduce the influence on the reflecting surface 11 of the reflection element 10. It is worth mentioning that, by providing two spaced-apart partition areas 331 near each side edge, it is helpful to increase the elastic coefficient of the second fixing portion 32, thereby reducing the stress deformation of the second fixing portion 32.

It should be understood that, each side edge may also correspond to three or more partition areas 331 arranged at intervals, and the present application does not impose any specific limitation on this.

### EXAMPLE 3

As shown in FIG. 9, the differences of Example 3 relative to Example 1 lie in that: each of the first side edge and the second side edge corresponds to two partition areas 331 with equal length and spaced apart, and each of the third side edge and the fourth side edge corresponds to one partition area 331, which is beneficial for targeted compensation of stress concentration areas. Particularly, the stress concentration point on the reinforcing member 30 may be close to the side edge of the partition area 331 with a smaller area. That is, the stress concentration point on the reinforcing member 30 will be close to the third side edge and the fourth side edge, which is beneficial to reduce the influence of stress on an area of the second fixing portion 32 which close to the first side edge and the second side edge, thereby reducing the influence of stress on the long sides of the reflection element 10, and thus helping to reduce the field curvature of the long sides of the reflection element 10. In addition, by adjusting the stress concentration position, the shape or position of the reflection element 10 can also be adjusted so that the optical center of the reflection element 10 coincides with or approaches to coincide with the expected optical center of the camera module 2, so as to eliminate optical decenter.

It should be understood that, according to actual applications, each of the first side edge and the second side edge may correspond to a partition area 331, and each of the third side edge and the fourth side edge each may correspond to two partition areas 331 with equal length and spaced apart, and the present application does not impose any specific limitation on this.

### EXAMPLE 4

As shown in FIG. 10, the differences of Example 4 relative to Example 1 lie in that: from the first side edge to the fourth side edge, each respectively corresponds to a number of partition areas 331 with equal length and spaced apart in a direction parallel to the side edge extension direction, and the partition areas 331 arranged on the reinforcing member 30 are symmetrical with respect to the midline of the reinforcing member 30 parallel to the long side direction, and symmetrical with respect to the midline of the reinforcing member 30 parallel to the short side direction, so that the stress transmitted from the first fixing portion 31 to the second fixing portion 32 is symmetrical along the two midlines, which is beneficial to avoiding non-central deformation of the second fixing portion 32, and is beneficial to reduce the uneven deformation of the reflecting surface 11 of the reflection element 10 which causes astigmatism, thereby improving the imaging quality of the camera module 2.

### EXAMPLE 5

As shown in FIG. 11, the differences of Example 5 relative to Example 4 lie in that: each partition area 331 is trapezoidal, and the long side direction of the trapezoid is arranged close to the first fixing portion 31, so that the first fixing portion 31 is suitable for generating a larger deformation to release stress, and the short side direction of the trapezoid is arranged toward the second fixing portion 32, so that the second fixing portion 32 has a greater rigidity to resist deformation. That is, the second fixing portion 32 is less likely to deform, which is beneficial to avoid deformation of the reflection element 10 connected to the second fixing portion 32.

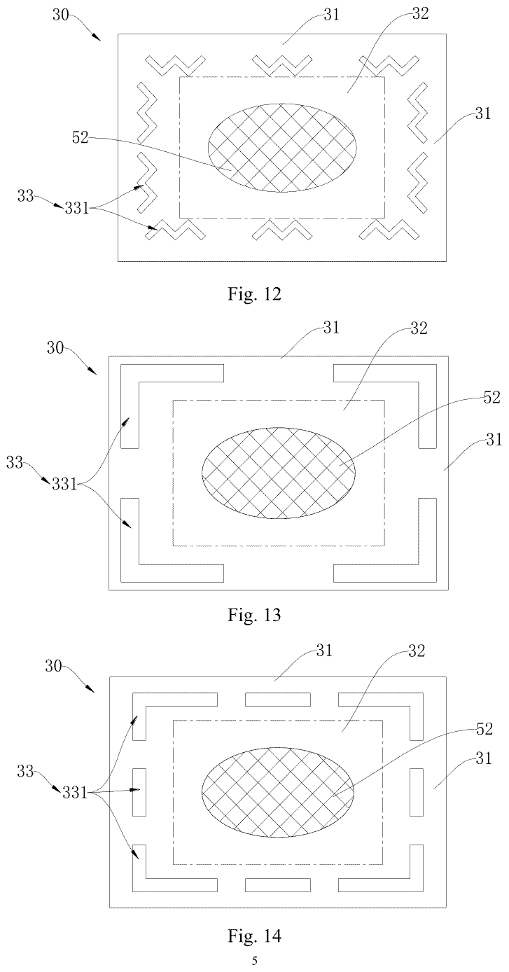

It is worth mentioning that, as shown in FIG. 12, the partition area 331 may also be in a “V” shape, a “W” shape, etc., so as to achieve the above effect, and the present application does not impose any specific limitation on this.

### EXAMPLE 6

As shown in FIG. 13, the reinforcing member 30 has four “L”-shaped partition areas 331, each of which is located at the four corners of the reinforcing member 30 and extends towards the middle section of the first side edge to the fourth side edge. On the basis of isolating the first fixing portion 31 from the second fixing portion 32, it is beneficial to reducing the deformation of the four corners of the second fixing portion 32, thereby reducing the influence of stress on the corners of the reflection element 10, which is beneficial to reducing the field curvature of the corners of the reflection element 10, thereby improving the reliability and stability of the reflection component 1, and improving the imaging quality of the camera module 2.

Furthermore, the four “L”-shaped partition areas 331 are symmetrical with respect to the midline of the reinforcing member 30 parallel to the long side direction, and symmetrical with respect to the midline of the reinforcing member 30 parallel to the short side direction, so that the stress transmitted from the first fixing portion 31 to the second fixing portion 32 is symmetrical along the two midlines, which is beneficial to avoiding non-central deformation of the second fixing portion 32, and is beneficial to reducing the uneven deformation of the reflecting surface 11 of the reflection element 10 which causes astigmatism, thereby improving the imaging quality of the camera module 2.

### EXAMPLE 7

As shown in FIG. 14, Example 7 combines Example 4 with Example 6, which is beneficial to avoiding the non-centering deformation of the second fixing portion 32, thereby reducing the uneven deformation of the reflecting surface 11 of the reflection element 10 which causes astigmatism; and is also beneficial to reducing the influence of stress on the corners of the reflection element 10, thereby reducing the field curvature of the corners of the reflection element 10, which is beneficial to improving the reliability and stability of the reflection module 1, and improving the imaging quality of the camera module 2.

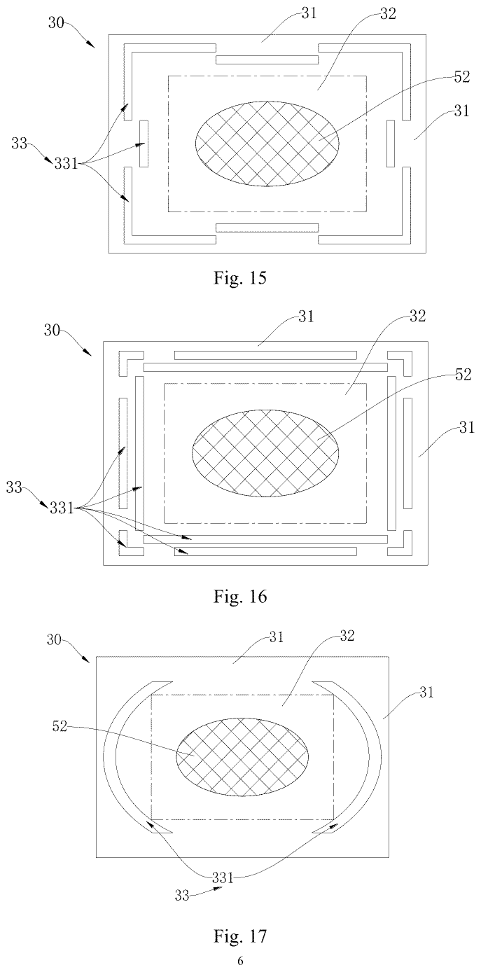

Furthermore, as shown in FIG. 15, a closed-loop path can also be formed between each partition area 331, which is beneficial to further isolating the first fixing portion 31 from the second fixing portion 32, reduce the area of the stress concentration region on the reinforcing member 30, and thereby reduce the deformation of the second fixing portion 32 and the reflection element 10 connected to the second fixing portion 32, which is beneficial to improve the reliability and stability of the reflection component 1.

### EXAMPLE 8

As shown in FIG. 16, Example 8 combines Example 2 with Example 6, which is beneficial to increasing the elastic coefficient of the second fixing portion 32, thereby reducing the stress deformation of the second fixing portion 32, and avoiding the second fixing portion 32 from producing non-centering deformation; and thereby reducing the uneven deformation of the reflecting surface 11 of the reflection element 10 which causes astigmatism, and is also beneficial to reducing the influence of stress on the corners of the reflection element 10, thereby reducing the field curvature of the corners of the reflection element 10, which is beneficial to improving the reliability and stability of the reflection component 1, and improving the imaging quality of the camera module 2.

### EXAMPLE 9

As shown in FIG. 17, the reinforcing member 30 has two arc-shaped partition areas 331, each of which is respectively arranged corresponding to the third side edge and the fourth side edge. A first fixing portion 31 is defined between the partition area 331 and the corresponding side, and a second fixing portion 32 is defined in the central area between the two partition areas 331. It should be understood that, when the outer contour of the reflection element 10 is circular, elliptical or D-Cut, the arc-shaped partition area 331 enables the outer contour of the second fixing portion 32 to better adapt to the outer contour of the reflection element 10, which is conducive to uniform distribution of stress. In addition, for a reflection element 10 with an outer contour that is not rotationally symmetrical, the strain generated during the molding or cutting process will be greater than that of a reflection element 10 with an outer contour that is rotationally symmetrical. Taking a D-Cut-shaped reflection element 10 as an example, due to the cutting process at the two straight edges, the stress at the two straight edges of the reflection element 10 will be more concentrated, which will cause the optical center to deviate toward the straight edge of the reflection element 10. By configuring an arc-shaped partition area 331, it is helpful to compensating for the offset of the optical center.

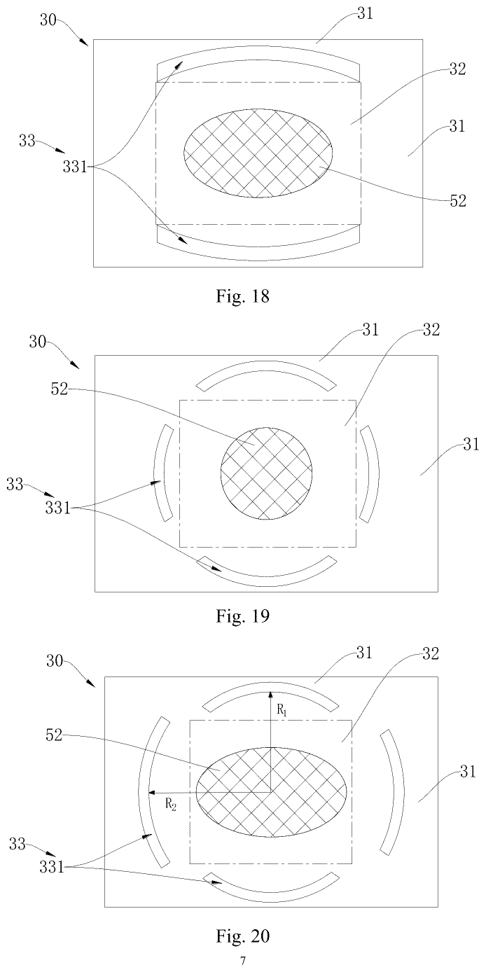

It is worth mentioning that, as shown in FIG. 18, the arc-shaped partition area 331 may also be configured corresponding to the first side edge and the second side edge according to actual applications, and the present application does not impose any specific limitation on this.

### EXAMPLE 10

As shown in FIG. 19, the reinforcing member 30 has four arc-shaped partition areas 331, all of which are located on the same imaginary circle and are evenly distributed along the circumferential direction. Each partition area 331 is respectively arranged corresponding to one of the first side edge to the fourth side edge, which is beneficial to making the stress transfer between the first fixing portion 31 and the second fixing portion 32 approach rotational symmetry, and is beneficial to avoiding the generation of uneven stress which causes uneven deformation of the reflecting surface 11 of the reflection element 10 connected to the second fixing portion 32.

Especially when a lens is provided on the object side or the image side of the reflection element 10, the stress of the reflecting surface 11 of the reflection element 10 is closer to rotational symmetry relative to the optical axis, so that the surface shape of the reflecting surface 11 is closer to the expected state, which is beneficial to making the optical performance of the reflecting surface 11 more uniform, and reducing the distortion of light during the reflection process. The light near the optical axis and the light at the edge are more likely to maintain the original direction of propagation, which is beneficial to reducing the separation phenomenon, and further helps to avoid defects such as coma, astigmatism and distortion in the imaging of the camera module 2.

It should be understood that, the number of the arc-shaped partition areas 331 may also be two, six, eight, etc., and the present application does not impose any specific limitation on this.

### EXAMPLE 11

As shown in FIG. 20, the differences of Example 11 relative to Example 10 lie in that: the two partition areas 331 corresponding to the first side edge and the second side edge are located on an imaginary circle with a radius of R₁, and the two partition areas 331 corresponding to the third side edge and the fourth side edge are located on an imaginary circle with a radius of R₂, wherein R₁<R₂.

It should be understood that, when the matching surface 12 of the reflection element 10 is rectangular, in order to ensure the bonding strength between the reflection element 10 and the second fixing portion 32 of the reinforcing member 30, the area of the first adhesive member 51 on the first fixing portion 31 between the first side edge and the partition area 331, and between the second side edge and the partition area 331 is relatively large, so that the stress generated by curing shrinkage is also relatively large and needs to be released using the partition area 331 corresponding to the first side edge and the second side edge. Furthermore, it is more difficult for the second fixing portion 32 to release stress by utilizing the partition area 331 corresponding to the first side edge and the second side edge. By configuring R₁<R₂, the second fixing portion 32 can have a larger size in the direction parallel to the long side, which is beneficial for bearing the stress generated by the second adhesive member 52 during curing shrinkage, thereby helping to reduce the deformation of the second fixing portion 32 and reduce the impact on the reflection element 10 connected to the second fixing portion 32, which is beneficial for improving the reliability and stability of the reflection component 1.

### EXAMPLE 12

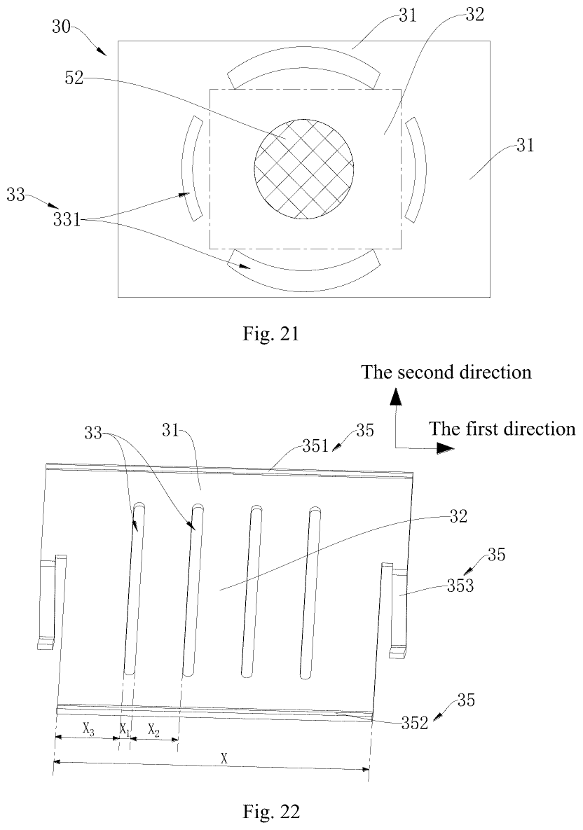

As shown in FIG. 21, the differences of Example 12 relative to Example 10 lie in that: the widths of the two partition areas 331 corresponding to the first side edge and the second side edge are larger, and the widths of the two partition areas 331 corresponding to the third side edge and the fourth side edge are smaller. It should be understood that, when the matching surface 12 of the reflection element 10 is rectangular, in order to ensure the bonding strength between the reflection element 10 and the second fixing portion 32 of the reinforcing member 30, the area of the first adhesive member 51 on the first fixing portion 31 between the first side edge and the partition area 331, and between the second side edge and the partition area 331 is larger, so that the stress generated by curing shrinkage is also larger. By configuring the partition area 331 with a larger width, it is beneficial to releasing the stress, so as to reduce the impact on the second fixing portion 32, and reduce the impact on the reflection element 10 connected to the second fixing portion 32, which is beneficial to improving the reliability and stability of the reflection component 1.

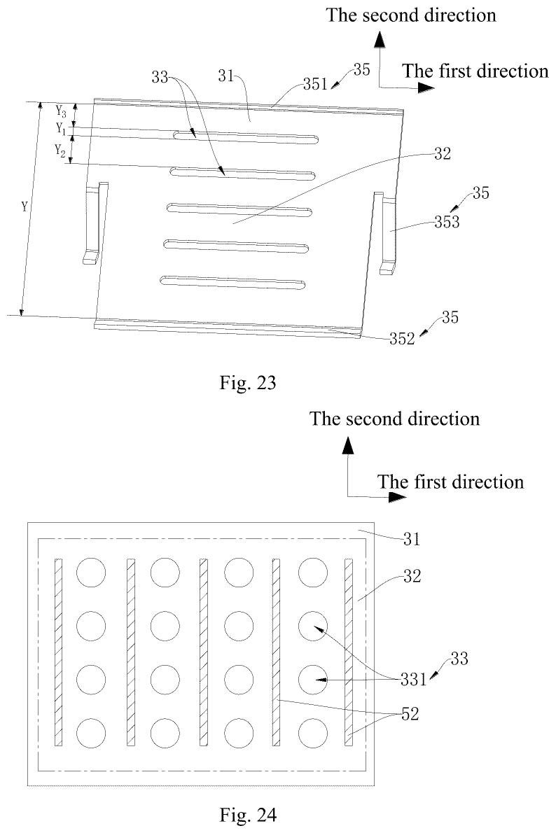

In some examples, as shown in FIGS. 22-23, the partition gap 33 comprises a plurality of partition areas 331 disposed at intervals, and at least some of the partition areas 331 are distributed at intervals on the second fixing portion 32, which is beneficial for releasing stress of the reinforcing member 30 to reduce deformation of the reinforcing member 30. Furthermore, in the thickness direction of the reflection element 10, the center of the projection area of the matching surface 12 on the reinforcing member 30 is defined as the central area, and the area of the central area is 20-30% of the total area of the projection area. The central area at least partially overlaps with the partition area 331, thereby reducing the strain in the middle area of the reflecting surface 11 of the reflection element 10, making the surface shape of the reflecting surface 11, especially the surface shape of the middle area to be closer to the expected state, reducing the distortion of light during the reflection process, and helping to improve the imaging quality of the camera module 2. Several examples are provided below to further illustrate the technology of the present application.

### EXAMPLE 13

As shown in FIG. 22, each partition area 331 extends in the second direction, and the partition areas 331 are spaced apart in the first direction. The size of the partition area 331 in the first direction is X₁, the distance between two adjacent partition areas 331 is X₂, and the distance from the partition area 331 closest to the short side of the reinforcing member 30 to the short side of the reinforcing member 30 is X₃. X is a size of the matching surface 12 of the reflection element 10 in the first direction. The first direction is parallel to the long side of the reinforcing member 30, and the second direction is parallel to the short side of the reinforcing member 30.

X₂ satisfies: 3X₁≤X₂≤6X₁, or 0.5 mm≤X₂≤2 mm, or 0.05X≤X₂≤0.2X, so that there is enough area between two adjacent partition areas 331 for bonding with the movable carrier 20 and the reflection element 10, thereby enabling the movable carrier 20, the reinforcing member 30 and the reflection element 10 to be reliably bonded. Furthermore, the stress of each part of the reinforcing member 30 can be isolated by the partition area 331, so that the stress distribution is more dispersed, which is beneficial to avoiding stress concentration, thereby reducing the influence of the stress of the reinforcing member 30 on the reflection element 10 connected to the second fixing portion 32, reducing the deformation of the reflecting surface 11 of the reflection element 10, and helping to make the surface shape of the reflecting surface 11, especially the surface shape of the middle area, to be closer to the expected state.

In a particular example, X₁=0.4 mm, and X₂=1.3 mm. In a particular example, X₁=0.3 mm, and X₂=1.8 mm. In a particular example, X₁=0.3 mm, and X₂=1.2 mm.

X₃ satisfies: X₃≥X₂, so that the rigidity of the peripheral region of the reinforcing member 30 is greater than the rigidity of the middle region of the reinforcing member 30. It should be understood that, the peripheral area of the reinforcing member 30 is defined as the first fixing portion 31 for bonding with the movable carrier 20. The first fixing portion 31 has greater rigidity, which is beneficial for resisting the stress generated by the curing shrinkage of the first adhesive member 51, thereby reducing the deformation of the first fixing portion 31.

Furthermore, at least part of the partition area 331 is located in the second fixing portion 32, so that the stress on the second fixing portion 32 is more dispersed, which is beneficial to avoiding stress concentration, making the reinforcing member 30 smoother, thereby improving the flatness of the reinforcing member 30, and thereby reducing the impact of the deformation of the reinforcing member 30 on the reflection element 10, so that the surface shape of the reflecting surface 11 of the reflection element 10 is closer to the expected state, thereby improving the reliability and stability of the reflection component 1.

Furthermore, a part of the partition area 331 may be located between the first fixing portion 31 and the second fixing portion 32 to isolate the first fixing portion 31 from the second fixing portion 32, thereby preventing the stress of the first fixing portion 31 from being transferred to the second fixing portion 32.

It is worth mentioning that, the arrangement of each partition area 331 is symmetrical with respect to the midline of the reinforcing member 30 which is parallel to the first direction, and symmetrical with respect to the midline of the reinforcing member 30 which is parallel to the second direction, thereby facilitating uniform stress distribution across the reinforcing member 30 and reducing the risk of optical-center shift of the reflection element 10.

### EXAMPLE 14

As shown in FIG. 23, each partition area 331 extends in the first direction, and the partition areas 331 are spaced apart in the second direction. The size of the partition area 331 in the second direction is Y₁, the distance between two adjacent partition areas 331 is Y₂, and the distance from the partition area 331 closest to the long side of the reinforcing member 30 to the long side of the reinforcing member 30 is Y₃. Y is the size of the matching surface 12 in the second direction. The first direction is parallel to the long side of the reinforcing member 30, and the second direction is parallel to the short side of the reinforcing member 30.

Y₂ satisfies: 3Y₁≤Y₂≤6Y₁, or 0.5 mm≤Y₂≤2 mm, or 0.06Y≤Y₂≤0.25Y, so that there is enough area between two adjacent partition areas 331 for bonding with the movable carrier 20 and the reflection element 10, thereby enabling the movable carrier 20, the reinforcing member 30 and the reflection element 10 to be reliably bonded. Furthermore, the stress of each part of the reinforcing member 30 can be isolated by the partition area 331, so that the stress distribution is more dispersed, which is beneficial to avoiding stress concentration, thereby reducing the influence of the stress of the reinforcing member 30 on the reflection element 10 connected to the second fixing portion 32, reducing the deformation of the reflecting surface 11 of the reflection element 10, and helping to make the surface shape of the reflecting surface 11, especially the surface shape of the middle area, to be closer to the expected state.

In a particular example, Y₁=0.4 mm, and Y₂=1.3 mm. In a particular example, Y₁=0.3 mm, and Y₂=1.8 mm. In a particular example, Y₁=0.3 mm, and Y₂=1.2 mm.

Y₃ satisfies: Y₃≥Y₂, so that the rigidity of the peripheral region of the reinforcing member 30 is greater than the rigidity of the middle region of the reinforcing member 30. It should be understood that, the peripheral area of the reinforcing member 30 is defined as the first fixing portion 31 for bonding with the movable carrier 20. The first fixing portion 31 has greater rigidity, which is beneficial for resisting the stress generated by the curing shrinkage of the first adhesive member 51, thereby reducing the deformation of the first fixing portion 31.

Furthermore, at least part of the partition area 331 is located in the second fixing portion 32, so that the stress on the second fixing portion 32 can be more dispersed, which is beneficial to avoiding stress concentration, making the reinforcing member 30 more flat, thereby improving the flatness of the reinforcing member 30, and further reducing the influence of the deformation of the reinforcing member 30 on the reflection element 10, so that the surface shape of the reflecting surface 11 of the reflection element 10 is closer to the expected state, thereby improving the reliability and stability of the reflection component 1.

Furthermore, a part of the partition area 331 may be located between the first fixing portion 31 and the second fixing portion 32 to isolate the first fixing portion 31 from the second fixing portion 32, thereby preventing the stress of the first fixing portion 31 from being transferred to the second fixing portion 32.

It is worth mentioning that, the arrangement of each partition area 331 is symmetrical with respect to the midline of the reinforcing member 30 parallel to the first direction, and symmetrical with respect to the midline of the reinforcing member 30 parallel to the second direction, which is beneficial to achieving uniform stress on the reinforcing member 30 and to reducing the risk of optical-center deviation of the reflection element 10.

### EXAMPLE 15

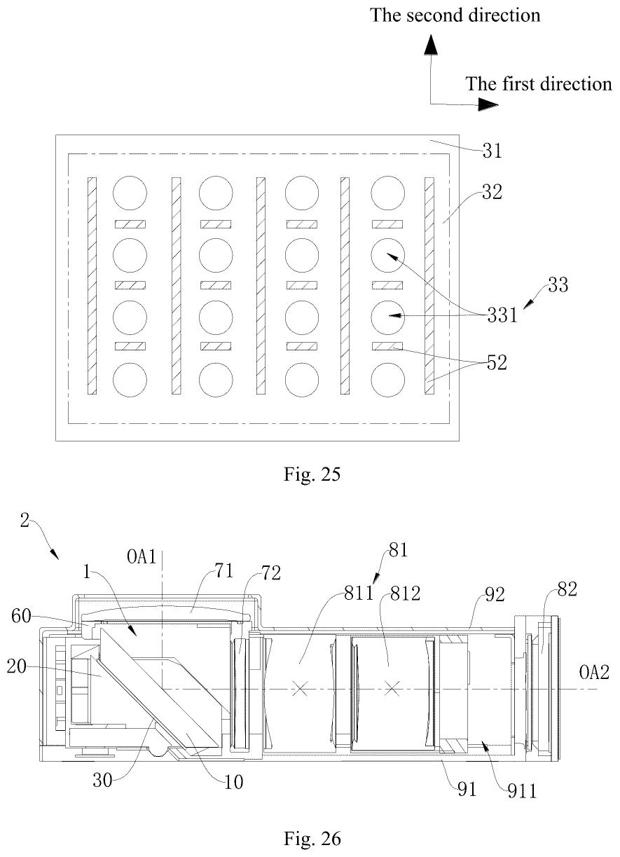

As shown in FIGS. 24-25, each of the partition areas 331 is circular, and at least some of the partition areas 331 are distributed in an array on the second fixing portion 32. It should be understood that, the circular partition area 331 can reduce the stress concentration of the reinforcing member 30, making the stress distribution of the reinforcing member 30 more uniform, thereby reducing the risk of positional offset of the optical center of the reflection element 10. It is worth mentioning that, the circular partition area 331 has little effect on the overall structural strength of the reinforcing member 30, which is conducive to maintaining the integrity of the structure and further reducing the effect of the partition area 331 on the local strength of the second fixing portion 32. In addition, the circular partition area 331 can release stress more effectively, which is beneficial to reducing the influence of the deformation of the first fixing portion 31 on the reflection element 10, so that the surface shape of the reflecting surface 11 of the reflection element 10 is closer to the expected state, thereby improving the reliability and stability of the reflection component 1.

In a particular example, as shown in FIG. 24, a plurality of second adhesive members 52 extend in the second direction and are disposed between the partition areas 331 at intervals in the first direction, thereby enabling reliable bonding between the second fixing portion 32 and the reflection element 10. It is worth mentioning that, the arrangement of each second adhesive member component 52 is symmetrical with respect to the midline of the reinforcing member 30 which is parallel to the first direction, and is symmetrical with respect to the midline of the reinforcing member 30 which is parallel to the second direction, thereby facilitating achieving uniform stress on the reflection element 10, and reducing the risk of positional offset of the optical center of the reflection element 10.

In another particular example, as shown in FIG. 25, a part of the second adhesive members 52 extend in the second direction and are spaced between the partition areas 331 in the first direction, and another part of the second adhesive member 52 extends in the first direction and is distributed in an array between the partition areas 331. It should be understood that, the crisscrossed arrangement of the second adhesive members 52 is beneficial to increasing the bonding area between the second fixing portion 32 and the reflection element 10, thereby improving the bonding reliability between the reinforcing member 30 and the reflection element 10. In addition, the second adhesive member 52 extending in the second direction and the second adhesive member 52 extending in the first direction are arranged at intervals, which is beneficial to avoiding a large accumulation of curing stress of the second adhesive member 52, thereby further reducing the influence of the curing stress of the second adhesive member 52 on the reflection element 10, so that the surface shape of the reflecting surface 11 of the reflection element 10 is closer to the expected state, thereby improving the reliability and stability of the reflection component 1.

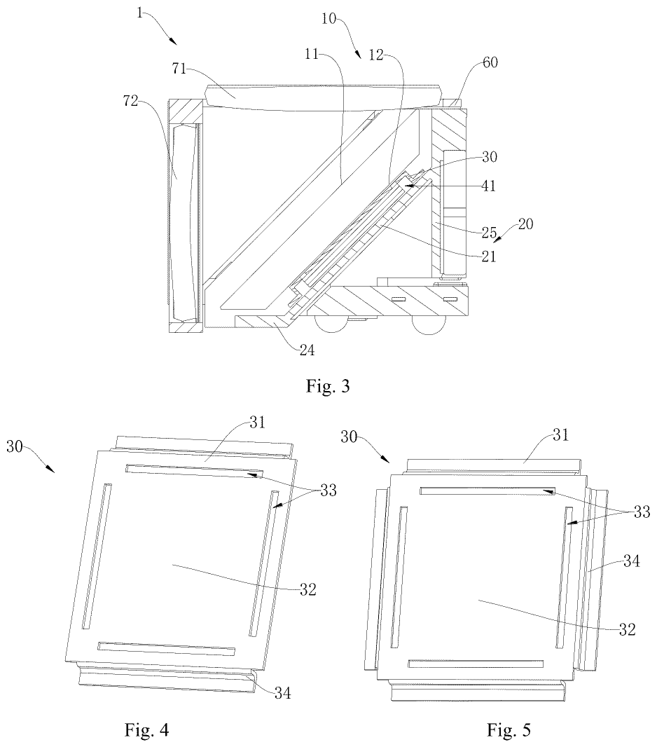

In some examples, as shown in FIGS. 3-5, the reinforcing member 30 further comprises a supporting portion 34, which is capable of connecting the first fixing portion 31 and the second fixing portion 32 so that the plane where the first fixing portion 31 is located and the plane where the second fixing portion 32 is located are different planes and parallel with each other, and in the thickness direction of the reinforcing member 30, the projection of the first fixing portion 31 and the projection of the second fixing portion 32 do not overlap, and the partition gaps 33 are arranged around the edge of the second fixing portion 32; the first fixing portion 31 is bonded to the movable carrier 20 via the first adhesive member 51, to define the first gap 41 among the first fixing portion 31, the supporting portion 34 and the movable carrier 20; the second fixing portion 32 is bonded to the matching surface 12 via the second adhesive member 52, to define the second gap 42 between the second fixing portion 32 and the matching surface 12, and the second gap 42 is located at the periphery of the second adhesive member 52.

It should be understood that, the supporting portion 34 facilitates increasing the distance between the second fixing portion 32 and the movable carrier 20, i.e., increases the first gap 41, so as to further avoid contact between the reinforcing member 30 and the movable carrier 20 when the reinforcing member 30 and the movable carrier 20 are deformed due to temperature changes. Especially when the reflection component 1 or the camera module 2 falls, the movable carrier 20 and the reinforcing member 30 may produce large deformation. By increasing the first gap 41, a buffer distance can be provided, which is beneficial to avoiding impact and collision between the movable carrier 20 and the reinforcing member 30, thereby better protecting the reflection element 10, the reinforcing member 30 and the movable carrier 20, thereby improving the reliability and impact resistance of the reflection component 1.

It is worth mentioning that, the supporting portion 34 can release stress through deformation, which is beneficial to further reducing the impact of the curing shrinkage of the first adhesive member 51 on the second fixing portion 32, and is beneficial to reducing the impact on the reflection element 10 connected to the second fixing portion 32, thereby further reducing the risk of deformation of the reflecting surface 11. In addition, by increasing the first gap 41, it is also beneficial to the heat dissipation of the movable carrier 20 and the reinforcing member 30, and the deformation and stress of the movable carrier 20 and the reinforcing member 30 are further reduced.

In at least one example, as shown in FIG. 4, the first fixing portions 31 are disposed at two opposite side edges of the second fixing portion 32, and the supporting portions 34 are also located at two opposite side edges of the second fixing portion 32, so as to connect the first fixing portion 31 and the second fixing portion 32. It should be understood that, only providing the supporting portion 34 and the first fixing portion 31 on opposite side edges of the second fixing portion 32 is conducive to reducing the processing difficulty of the reinforcing member 30, thereby reducing the production cost of the reinforcing member 30 and improving production efficiency; it is also conducive to reducing the overall size of the reflection component 1.

In at least one other example, as shown in FIG. 5, the first fixing portions 31 are disposed at four sides of the second fixing portion 32, and the supporting portions are also located at four sides of the second fixing portion 32, so as to connect the first fixing portion 31 and the second fixing portion 32. It should be understood that providing the supporting portion 34 and the first fixing portion 31 on the four sides of the second fixing portion 32 is beneficial to increasing the bonding area between the first fixing portion 31 and the movable carrier 20 and improving the connection strength and connection reliability between the reinforcing member 30 and the movable carrier 20.

In some examples, as shown in FIGS. 1 and 3, the movable carrier 20 comprises: a carrier mounting wall 21, a first carrier side wall 22, and a second carrier side wall 23. The carrier mounting wall 21 is obliquely arranged to define a mounting surface 211 on the surface of the carrier mounting wall 21 facing the reflection element 10. The mounting surface 211 is suitable for being bonded and fixed to the first fixing portion 31. The first carrier side wall 22 and the second carrier side wall 23 are located at opposite sides of the carrier mounting wall 21 at intervals in the direction of the third axis A3. An accommodating cavity 26 is formed among the first carrier side wall 22, the second carrier side wall 23 and the mounting surface 211, and the accommodating cavity 26 is used for accommodating the reflection element 10.

That is, the reinforcing member 30 and the reflection element 10 are both arranged in the accommodating cavity 26, the reinforcing member 30 is located between the reflection element 10 and the carrier mounting wall 21, at least a part of the first fixing portion 31 of the reinforcing member 30 is connected to the carrier mounting wall 21 via the first adhesive member 51, and at least a part of the second fixing portion 32 is connected to the carrier mounting wall 21 via the second adhesive member 52. It should be understood that, the first carrier side wall 22 and the second carrier side wall 23 can play the role of assisting in positioning the reflection element 10 and protecting the reflection element 10.

In some examples, as shown in FIGS. 1 and 3, the movable carrier 20 further comprises a carrier back wall 25, which is located between the first carrier side wall 22 and the second carrier side wall 23, and is able to connect the first carrier side wall 22, the second carrier side wall 23 and the carrier mounting wall 21, thereby facilitating to improve the structural strength and structural reliability of the movable carrier 20, and playing a role in protecting the reflection element 10. Furthermore, the carrier back wall 25 and the carrier mounting wall 21 are spaced apart from each other along the second optical axis OA2, which helps to prevent the force of the carrier back wall 25 from being transmitted to the carrier mounting wall 21 and affecting the reflection element 10.

In some examples, the thickness of the reinforcing member 30 is H, the thickness of the carrier mounting wall 21 is L, and the thickness of the reflection element 10 is T, and L≤H≤T. It should be understood that, under the condition that the movable carrier 20 meets the minimum wall thickness of injection molding, the smaller the wall thickness of the movable carrier 20 is, the smaller the stress and strain generated when heated is. That is, reducing the thickness L of the carrier mounting wall 21 is helpful to reducing the stress and strain generated by the carrier mounting wall 21 when heated, thereby reducing the influence on the reinforcing member 30 and the reflection element 10.

Furthermore, the reinforcing member 30 is made of metal, and the thickness H of the reinforcing member 30 is greater than or equal to the thickness L of the carrier mounting wall 21, which is beneficial to compensating for the structural strength of the carrier mounting wall 21 and improve the impact resistance of the carrier mounting wall 21. Furthermore, since the reinforcing member 30 is made of metal, its thermal expansion coefficient is higher than that of the reflection element 10. By making the thickness H of the reinforcing member 30 less than or equal to the thickness T of the reflection element 10, it is beneficial to reducing the influence of the deformation of the reinforcing member 30 caused by temperature on the reflection element 10, which in turn helps to reduce the deformation of the reflecting surface 11 of the reflection element 10, thereby improving the stability and reliability of the reflection component 1.

In some examples, the area of the first fixing portion 31 is N₁, and the area of the second fixing portion 32 is N₂, and N₁≥0.5N₂. It should be understood that, by configuring N₁≥0.5N₂, it is helpful to ensure that the first fixing portion 31 has a larger area for bonding with the movable carrier 20, thereby improving the connection strength and connection reliability between the reinforcing member 30 and the movable carrier 20. In addition, it is also beneficial to improve the isolation effect of the partition gap 33, thereby reducing the stress transmitted from the first fixing portion 31 to the second fixing portion 32, helping to reduce or even avoid deformation of the reflecting surface 11 of the reflection element 10, and improving the reliability and stability of the reflection component 1.

In some examples, the area of the matching surface 12 of the reflection element 10 is M, and the area of the matching surface 12 which is bonded to the second fixing portion 32 is M₁, and 0.3M≤M₁≤0.7M. It should be understood that, the area of the matching surface 12 which is bonded to the second fixing portion 32 is also the area of the second adhesive member 52. By ensuring that 0.3M≤M₁≤0.7M, it is helpful to reduce the amount of adhesive used, thereby reducing the production cost of the reflection component 1. Moreover, on the basis of ensuring reliable fixed connection between the reflection element 10 and the reinforcing member 30, it is also beneficial to reduce the stress transferred between the reinforcing member 30, the second adhesive member 52 and the reflection element 10. In addition, the area of the second gap 42 around the second adhesive member 52 is increased, thereby reducing the risk of contact between the reinforcing member 30 and the reflection element 10 after being deformed by heat.

In other examples, the reflection element 10 may also be connected to the second fixing portion 32 of the reinforcing member 30 by welding, thereby shortening the heating time of the reflection element 10 and the reinforcing member 30, and reducing the stress and strain of the reflection element 10 and the reinforcing member 30.

In some examples, the thermal expansion coefficient of the reflection element 10 is C₁, and the thermal expansion coefficient of the reinforcing member 30 is C₂, which satisfies: 0.25C₂≤C₁≤0.75C₂. It should be understood that, by ensuring that 0.25C₂≤C₁≤0.75C₂, the forces on the upper and lower surfaces of the second adhesive member 52 can be more balanced, which helps to avoid the risk of delamination or surface cracking of the second adhesive member 52.

Particularly, if the thermal expansion coefficient C₁ of the reflection element 10 and the thermal expansion coefficient C₂ of the reinforcing member 30 differ too greatly, then during the process of thermal curing of the adhesive to form the second adhesive member 52, the stress on one surface of the second adhesive member 52 may be too greater than the stress on the other surface, thereby causing stress concentration and causing delamination or surface fragmentation of the second adhesive member 52. In the present example, 0.25C₂≤C₁≤0.75C₂ is satisfied, which is beneficial to making the force applied on the second adhesive member 52 more balanced, thereby reducing or even avoiding stress concentration, and improving the bonding strength and bonding reliability between the reinforcing member 30 and the reflection element 10. That is to say, although the area of the second adhesive member 52 is small because 0.3M≤M₁≤0.7M is satisfied, the reinforcing member 30 and the reflection element 10 can still be reliably fixedly connected by satisfying 0.25C₂≤C₁≤0.75C₂.

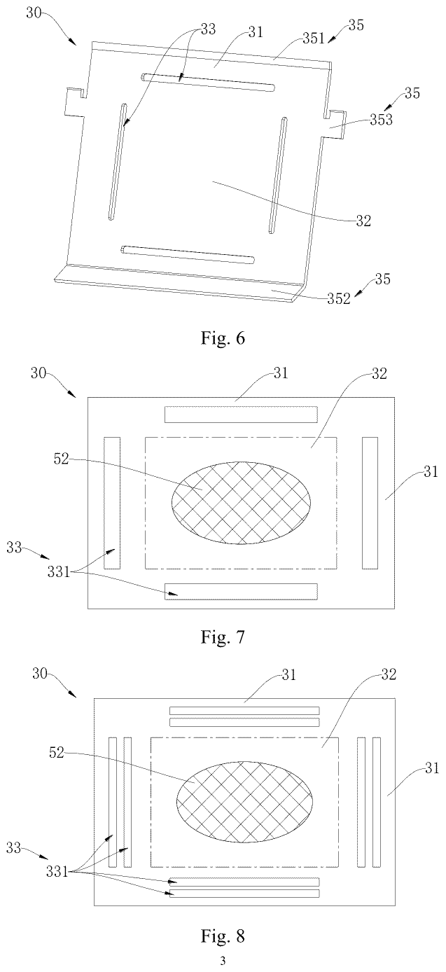

In some examples, as shown in FIG. 6, the reinforcing member 30 further comprises an embedding portion 35, which bends and extends from the first fixing portion 31 toward the movable carrier 20 and is embedded in the movable carrier 20. At least a part of the first fixing portion 31 is embedded in the movable carrier 20, so that the first fixing portion 31 and the movable carrier 20 are interlocked, to define the first gap 41 between the reinforcing member 30 and the movable carrier 20; the second fixing portion 32 is bonded to the matching surface 12 via the second adhesive member 52, to define the second gap 42 between the reinforcing member 30 and the matching surface 12, and the second gap 42 is located at the periphery of the second adhesive member 52.

Particularly, the reinforcing member 30 is formed on the movable carrier 20 by insert injection molding, which helps to avoid providing the adhesive between the first fixing portion 31 of the reinforcing member 30 and the movable carrier 20, thereby facilitating to avoid shrinkage stress during thermal curing of the adhesive to form the first adhesive member 51. That is, using the insert molding process instead of bonding is helpful to reduce the stress between the first fixing portion 31 and the movable carrier 20, thereby helping to reduce the impact on the second fixing portion 32 and the reflection element 10 connected to the second fixing portion 32.

In some examples, as shown in FIGS. 1 and 3, the movable carrier 20 comprises a carrier bottom wall 24, a first carrier side wall 22, a second carrier side wall 23 and a carrier back wall 25. The carrier bottom wall 24 is arranged perpendicular to the first optical axis OA1, the first carrier side wall 22 and the second carrier side wall 23 are located at opposite sides of the carrier bottom wall 24 in the direction of the third axis A3, and the carrier back wall 25 connects the first carrier side wall 22 and the second carrier side wall 23; the reinforcing member 30 is obliquely arranged between the first carrier side wall 22 and the second carrier side wall 23, the second fixing portion 32 of the reinforcing member 30 is spaced apart from the carrier bottom wall 24 in the direction of the first optical axis OA1, and the second fixing portion 32 of the reinforcing member 30 is spaced apart from the carrier back wall 25 in the direction of the second optical axis OA2, that is, the reinforcing member 30 is suspended. Furthermore, the embedding portion 35 of the reinforcing member 30 is embedded in at least one of the carrier bottom wall 24, the first carrier side wall 22, the second carrier side wall 23 and the carrier back wall 25, thereby improving the connection strength and connection reliability between the reinforcing member 30 and the movable carrier 20.

In at least one example, as shown in FIG. 6, the embedding portion 35 comprises a first embedding portion 351. When the reinforcing member 30 is embedded in the movable carrier 20, the first embedding portion 351 bends and extends along the first optical axis OA1 to be embedded in the carrier back wall 25. In at least one example, as shown in FIG. 6, the embedding portion 35 comprises a second embedding portion 352. When the reinforcing member 30 is embedded in the movable carrier 20, the second embedding portion 352 bends and extends along the second optical axis OA2 to be embedded in the carrier bottom wall 24. In at least one example, as shown in FIG. 6, the embedding portion 35 comprises a third embedding portion 353. When the reinforcing member 30 is embedded in the movable carrier 20, the third embedding portion 353 extends along the third axis A3 to embed into the first carrier side wall 22 and the second carrier side wall 23.

In some examples, as shown in FIGS. 1 and 3, the reflection component 1 further comprises: a bracket 60, a first lens 71 and a second lens 72. The bracket 60 is fixed to the movable carrier 20 to be suitable for moving synchronously with the movable carrier 20. The first lens 71 is carried by the bracket 60 to be arranged opposite to the reflection element 10 along the first optical axis OA1, and the second lens 72 is carried by the bracket 60 to be arranged opposite to the reflection element 10 along the second optical axis OA2.

In some examples, the first lens 71 of the reflection component 1 has at least one convex surface, so that the first lens 71 has positive optical power for focusing light; the second lens 72 has at least one concave surface, so that the second lens 72 has negative optical power for expanding light. It is worth mentioning that, the first lens 71 defines the first optical axis OA1, and the second lens 72 defines the second optical axis OA2. The first optical axis OA1 is parallel to the first direction, and the second optical axis OA2 is parallel to the second direction.

That is, the first lens 71 has positive optical power, and is able to converge light, so that the light along the first optical axis OA1 is converged after passing through the first lens 71, thereby increasing the amount of light entering without changing the physical aperture of the camera module 2. In other words, it is equivalent to increasing the effective aperture of the camera module 2, thereby improving the imaging quality of the camera module 2 in a low-light environment.

Furthermore, the light rays converged by the first lens 71 remain converged after being reflected by the reflection element 10, and thus the required size of the second lens 72 is also smaller, which is beneficial to reducing the size of the second lens 72 in the first direction, and is beneficial to reducing the optical effective diameter of each optical lens in the lens component 81 in the first direction, thereby reducing the shoulder height of the camera module 2, which is beneficial to meeting the development trend of lighter and thinner electronic devices.

As mentioned above, the second lens 72 has a negative optical power, and is capable of expanding the light, so that the light along the second optical axis OA2 is expanded after passing through the second lens 72, thereby increasing the coverage area of the light reaching the lens component 81. The reflection element 10 moves during the optical image stabilization operation. Since the light coverage area increases, the movement of the reflection element 10 has a relatively small effect on the position of the light on the lens component 81, which is beneficial to improving image stability and making the picture more stable during shooting.

It should be understood that, since the first lens 71 has a focusing effect and the second lens 72 has an expanding effect, the surface shape of the reflecting surface 11 of the reflection element 10 is particularly important. If the reflecting surface 11 has a large protrusion or depression, the light focused by the first lens 71 will not be able to accurately converge to the predetermined focal position on the second lens 72 after being reflected by the reflection element 10, thereby causing aberrations. Furthermore, the beam expansion effect of the second lens 72 may further amplify the aberration, resulting in blurred final imaging of the camera module 2 and loss of details. Large protrusions or depressions on the reflecting surface 11 may also scatter light and form stray light, or the light may enter the imaging system after multiple reflections, resulting in an increase in the final imaging noise of the camera module 2, or even ghosting or other abnormal light spots, affecting the readability and aesthetics of the image. In addition, if the stress distribution of the reflecting surface 11 is uneven, resulting in uneven protrusions or depressions on the reflecting surface 11, the light at different positions will be offset to varying degrees, causing the image field to bend, resulting in inconsistent imaging quality at the center and edge of the image.

In this example, as described above, the first fixing portion 31 of the reinforcing member 30 is fixedly connected with the movable carrier 20, the second fixing portion 32 is fixedly connected with the matching surface 12 of the reflection element 10, and the partition gap 33 is located between the first fixing portion 31 and the second fixing portion 32, or is arranged on the second fixing portion 32, so as to isolate the first fixing portion 31 from the reflection element 10, and then when the movable carrier 20 is heated, the force generated by the deformation of the movable carrier 20 will be applied to the first fixing portion 31. Furthermore, stress can be absorbed by the first fixing portion 31 and the second fixing portion 32, and the partition gap 33 can further prevent stress from being transferred to the reflection element 10, thereby reducing the effect of the force generated by the deformation of the movable carrier 20 on the reflection element 10, which is beneficial to improving the reliability and stability of the reflection component 1.

That is to say, by providing the reinforcing member 30, it is helpful to improve the flatness of the reflecting surface 11, or make the surface shape of the reflecting surface 11 approach the expected surface shape, so that the propagation path of the light coincides with or approaches to coincide with the expected path, which is helpful to keep the light propagating along the path after being focused by the first lens 71, and reduce the deviation of the propagation path of the light after being expanded by the second lens 72, thereby improving the final imaging quality of the camera module 2.

It is worth mentioning that, through the assembly of the bracket 60 and the movable carrier 20, the relative position and relative angle between the first lens 71 and the second lens 72 of the reflection element 10 can be kept fixed, and then when the first lens 71, the reflection element 10 and the second lens 72 are driven to rotate together, the light maintains a relatively stable propagation path and propagation angle in the process of passing through the first lens 71 to be incident on the reflection element 10 and then reflected by the reflection element 10 to the second lens 72, which not only improves the clarity of the imaging, but also enhances the overall quality of the image. In addition, the relative position and relative angle between the first lens 71 and the second lens 72 of the reflection element 10 remain fixed, which is also beneficial to avoid setting up additional structures or algorithms to optimize the propagation path and angle of light, and is beneficial to reducing the design difficulty and manufacturing difficulty of the reflection component 1 and the camera module 2, as well as simplifying the driving structure and improving the reliability and stability of the reflection component 1.

Furthermore, the first lens 71 and the second lens 72 are carried on the bracket 60. Since the size of the bracket 60 is smaller than the base 91 of the camera module 2, compared with the first lens 71 and the second lens 72 being fixed to the base 91, in this example, the first lens 71 and the second lens 72 are installed on the bracket 60, which is beneficial to reducing the size of the first lens 71 and the second lens 72 and reducing the weight of the first lens 71 and the second lens 72. In addition, the gaps between the first lens 71, the reflection element 10 and the second lens 72 are smaller, which is beneficial for making the structure of the reflection component 1 more compact.

A camera module 2, as shown in FIG. 26, comprises: the above reflection component 1, a lens component 81, an imaging component 82, a base 91 and a shell 92. The lens component 81 is held on the light reflection path of the reflection component 1. The imaging component 82 receives the light emitted by the lens component 81 to perform imaging. The base 91 has a receiving cavity 911, and the reflection component 1 and the lens component 81 are disposed in the receiving cavity 911. The shell 92 is disposed on the base 91 to protect the reflection component 1 and the lens component 81 in the receiving cavity 911.

In some examples, the lens component 81 comprises a plurality of lenses, and the lens component 81 is used to image the light onto an imaging surface of the imaging component 82. Particularly, the lens component 81 comprises a first lens group 811 and a second lens group 812, wherein the first lens group 811 and the second lens group 812 are arranged in sequence along the optical axis direction.

In a particular example, the first lens group 811 is a fixed lenses group, and the second lens group 812 is a focusing lenses group. That is, the first lens group 811 is fixed to the base 91, and the second lens group 812 is carried on the lens movable carrier, and the lens movable carrier is driven by the focusing drive assembly to carry the second lens group 812 to move in the second direction, and then the optical focusing function of the camera module 2 is realized by adjusting the relative positions of the first lens group 811 and the second lens group 812. In addition, the relative positions of the second lens group 812 and the imaging surface of the imaging component 82 can also be adjusted to switch the imaging mode of the camera module 2.

It should be understood that, the lens component 81 may further comprise a third lens group and/or a fourth lens group, wherein the third lens group and/or the fourth lens group may move in the second direction to achieve an optical zoom function; and the present application does not impose any specific restrictions on this.

In some examples, the imaging component 82 comprises: a chip circuit board, a photosensitive chip, and a plurality of electronic components. Particularly, the photosensitive chip and multiple electronic components are electrically connected to the chip circuit board. The photosensitive chip is used for receiving external light collected by the reflection component 1 for imaging, and is electrically connected to external electronic device through the chip circuit board. It should be understood that, the multiple electronic components comprise but are not limited to passive electronic devices such as resistors and capacitors, and driver chips, storage chips, etc.

Furthermore, the imaging component 82 further comprises a filter assembly, which comprises a filter element. The filter element is retained on the light-sensitive path of the photosensitive chip, and is disposed between the lens component 81 and the photosensitive chip. It should be understood that, the filter element is used for filtering the incident light entering the photosensitive chip, so as to filter out stray light such as infrared light that is not necessary for imaging in the incident light.

Furthermore, the filter assembly further comprises a filter element mounting frame; wherein the filter element is mounted and fixed on the filter element mounting frame, and corresponds to at least the photosensitive area of the photosensitive chip. Particularly, the filter element mounting frame has a light hole, and the incident light passing through the lens component 81 is incident on the photosensitive chip through the light hole. The filter element can be attached to the filter element mounting frame upright or upside down.

In a particular example, the filter element mounting frame is fixed to the chip circuit board. It is worth mentioning that, the imaging component 82 is fixed to the image side of the filter element through a filter element mounting frame; the imaging component 82 can also be fixed to the image side of the filter element through a chip circuit board; and the present application does not impose specific restrictions on this.

The basic principles, main features and advantages of the present application are described above. Those skilled in the art should understand that the present application is not limited to the above examples and examples. The above examples/examples and the specification only describe the principles of the present application. Various changes and improvements may be made to the present application without departing from the spirit and scope of the present application. These changes and improvements all fall within the protection scope of the present application. The protection scope of the present application is defined by the appended claims and their equivalents.

1. A reflection component, characterized by comprising:
a reflection element, which comprises a reflecting surface and a matching surface, wherein the reflecting surface is used for reflecting light propagating along the first optical axis to propagating along the second optical axis;
a movable carrier, which is used for carrying the reflection element;
a reinforcing member, which is arranged between the reflection element and the movable carrier so that the reflection element can be fixed to the movable carrier, wherein the reinforcing member comprises a first fixing portion, a second fixing portion and a partition gap which are integrally formed, and the first fixing portion is used for being fixedly connected with the movable carrier, and the second fixing portion is used for fixedly connected with the matching surface of the reflection element, and the first fixing portion is located at the peripheral side of the second fixing portion, and the projection of the fixed connection area between the first fixing portion and the movable carrier is offset from the projection of the fixed connection area between the second fixing portion and the matching surface in the thickness direction of the reflection element;
wherein the partition gap is located at the inner side of the first fixing portion, so that the partition gap is arranged between the first fixing portion and the second fixing portion, or is arranged on the second fixing portion so as to isolate the first fixing portion from the reflection element.

2. The reflection component according to claim 1, wherein in the thickness direction of the reflection element, a first gap is provided between the reinforcing member and the movable carrier, and a second gap is provided between the reinforcing member and the matching surface, and the projection of the first gap is offset from the projection of the second gap in the thickness direction of the reflection element.

3. The reflection component according to claim 2, wherein the first fixing portion and the second fixing portion extend in a same plane, and the first fixing portion is bonded to the movable carrier via a first adhesive member, and the first gap is located in the middle of the first adhesive member, and the second fixing portion is bonded to the matching surface via a second adhesive member, to define the second gap between the reinforcing member and the matching surface, and the second gap is located at the periphery of the second adhesive member, so that the projection of the first gap is offset from the projection of the second gap.

4. The reflection component according to claim 1, wherein the partition gap penetrates the reinforcing member in the thickness direction of the reinforcing member, and the partition gap is arranged around the second fixing portion, and is located between the first fixing portion and the second fixing portion, and the first fixing portion is suitable for being fixedly connected with the movable carrier, and the second fixing portion is suitable for being fixedly connected with the matching surface.

5. The reflection component according to claim 4, wherein the partition gap comprises a plurality of partition areas arranged at intervals, and the partition areas are distributed at intervals on the periphery of the second fixing portion to separate the first fixing portion from the second fixing portion.

6. The reflection component according to claim 1, wherein the partition gap comprises a plurality of partition areas arranged at intervals, and at least some of the partition areas are distributed at intervals on the second fixing portion, and in the thickness direction of the reflection element, the center of the projection area of the matching surface on the reinforcing member is defined as a central area, and the area of the central area is 20-30% of the total area of the projection area, and the central area overlaps at least partially with the partition areas.

7. The reflection component according to claim 6, wherein each of the partition areas extends in the second direction, and the partition areas are arranged at intervals in the first direction, the size of the partition area in the first direction is X₁, the distance between two adjacent partition areas is X₂, the distance from the partition area closest to the short side of the reinforcing member to the short side of the reinforcing member is X₃, and X₂ satisfies: 3X₁≤X₂≤6X₁, or 0.5 mm≤X₂≤2 mm, or 0.05X≤X₂≤0.2X; and X₃ satisfies: X₃≥X₂;
or, each of the partition areas extends in the first direction, and the partition areas are arranged at intervals in the second direction, the size of the partition area in the second direction is Y₁, the distance between two adjacent partition areas is Y₂, the distance from the partition area closest to the long side of the reinforcing member to the long side of the reinforcing member is Y₃, and Y₂ satisfies: 3Y₁≤Y₂≤6Y₁, or 0.5 mm≤Y₂≤2 mm, or 0.06Y≤Y₂≤0.25Y; and Y₃ satisfies: Y₃≥Y₂;
wherein X is the size of the matching surface of the reflection element in the first direction, and Y is the size of the matching surface in the second direction; the first direction is parallel to the long side of the reinforcing member, and the second direction is parallel to the short side of the reinforcing member.

8. The reflection component according to claim 6, wherein each of the partition areas is circular, and at least part of the partition areas are distributed in an array on the second fixing portion.

9. The reflection component according to claim 1, wherein the reinforcing member further comprises a supporting portion, and the supporting portion is capable of connecting the first fixing portion and the second fixing portion so that the plane where the first fixing portion is located and the plane where the second fixing portion is located are different planes and parallel to each other, and in the thickness direction of the reinforcing member, the projection of the first fixing portion and the projection of the second fixing portion do not overlap, and the partition gap is arranged around the edge of the second fixing portion, and the first fixing portion is bonded to the movable carrier via a first adhesive member, and the second fixing portion is bonded to the matching surface via a second adhesive member.

10. The reflection component according to claim 1, wherein the movable carrier comprises a carrier mounting wall, a first carrier side wall and a second carrier side wall, the carrier mounting wall is obliquely arranged to define a mounting surface on the surface of the carrier mounting wall facing the reflection element, and the mounting surface is suitable for being bonded and fixed to the first fixing portion, and the first carrier side wall and the second carrier side wall are located at opposite sides of the carrier mounting wall at intervals in a direction of a third axis, and an accommodating cavity is formed between the first carrier side wall, the second carrier side wall and the mounting surface, and the accommodating cavity is used for accommodating the reflection element.

11. The reflection component according to claim 10, wherein the thickness of the reinforcing member is H, the thickness of the carrier mounting wall is L, and the thickness of the reflection element is T, and L≤H≤T.

12. The reflection component according to claim 1, wherein the reinforcing member further comprises an embedding portion, which is bent and extended from the first fixing portion toward the movable carrier and embedded in the movable carrier, and at least part of the first fixing portion is embedded in the movable carrier so that the first fixing portion is connected with the movable carrier by embedding, and the second fixing portion is bonded to the matching surface via a second adhesive member.

13. The reflection component according to claim 12, wherein the movable carrier comprises a carrier bottom wall, a first carrier side wall, a second carrier side wall and a carrier back wall, and the carrier bottom wall is arranged perpendicular to the first optical axis, and the first carrier side wall and the second carrier side wall are located at opposite sides of the carrier bottom wall in the direction of a third axis, and the carrier back wall connects the first carrier side wall and the second carrier side wall, and the reinforcing member is obliquely arranged between the first carrier side wall and the second carrier side wall, and the second fixing portion of the reinforcing member is spaced apart from the carrier bottom wall in the direction of the first optical axis, and the second fixing portion of the reinforcing member is spaced apart from the carrier back wall in the direction of the second optical axis, and the embedding portion of the reinforcing member is embedded in at least one of the carrier bottom wall, the first carrier side wall, the second carrier side wall and the carrier back wall, and the third axis is perpendicular to the first optical axis and the second optical axis.

14. The reflection component according to claim 1, wherein at least one of the following conditions is satisfied:
the area of the first fixing portion is N₁, and the area of the second fixing portion is N₂, and N₁≥0.5N₂;
the area of the matching surface of the reflection element is M, and the area of the matching surface bonded to the second fixing portion is M₁, and 0.3M≤M₁≤0.7M; and
the thermal expansion coefficient of the reflection element is C₁, the thermal expansion coefficient of the reinforcing member is C₂, and 0.25C₂≤C₁≤0.75C₂.

15. The reflection component according to claim 1, further comprises a bracket, a first lens and a second lens, and the bracket is fixed to the movable carrier so as to be suitable for moving synchronously with the movable carrier, and the first lens is carried by the bracket to be arranged opposite to the reflection element along the first optical axis, and the second lens is carried by the bracket to be arranged opposite to the reflection element along the second optical axis.

16. A camera module comprising:
the reflection component according to claim 1;
a lens component, which is held on a light reflection path of the reflection component;
an imaging component, which receives the light emitted by the lens component to perform imaging;
a base, which has a receiving cavity, wherein the reflection component and the lens component are arranged in the receiving cavity; and
a shell covering the base.
